(19) United States
(12) Patent Application Publication
(10) Pub. No.: US 2004/0076485 A1
(43) Pub. Date: Apr. 22, 2004

(54) Aspirating means for a power hand tool, more particularly a router

(76) Inventor: Robert Kraus, Gablitz (AT)

Correspondence Address: FLYNN THIEL BOUTELL & TANIS, P.C., 2026 RAMBLING ROAD, KALAMAZOO, MI, 49008-1699, US

(21) Appl. No.: 10/674,992

(22) Filed: Sep. 30, 2003

(30) Foreign Application Priority Data
Oct. 18, 2002 (DE) 202 16 066.1
Mar. 14, 2003 (AT) GM 179/2003

(51) Int. Cl. B23C 1/00

(52) U.S. Cl. 409/137

(57) ABSTRACT

An aspiration means for a power hand tool, more particularly a router adapted to be set on the workpiece to be processed and is able to be moved in relation to the workpiece and the tool bit extends through workpiece, the support plate and is preferably able to be moved in relation to support plate vertically. There is a provision such that at the support plate of the tool a receiving orifice means is provided directed toward the tool, such opening being funnel-like, to receive waste, chips or the like, with which by way of a connection vacuum may be connected for the removal of the waste or, respectively, the chips.

### BACKGROUND OF THE INVENTION

The present invention relates to an aspirating means for a power hand tool, more particularly a router, able to be set on a workpiece to be worked on using a support plate and is able to be moved in relation to the workpiece and the tool, more particularly a router bit, extending through the support plate and being preferably able to be adjusted in relation to the support plate in the vertical direction.

### THE PRIOR ART

For the production of furnishings such as furniture, interior walls, fitted kitchens or the like it is known to employ the most various different materials. For processing the surface of the materials and for producing special shapes and prominent edges a large number of different tools such as saws and routers are known, with which such materials may be worked. In addition to the employment of wood or materials consisting essentially thereof, increasing use is being made of customized plastics in the form of board, such plastics being characterized by correspondingly outstanding resistance and hardness properties. Unlike wood such plastics as for example plastics containing ground mineral, can only be commercially produced in the form of relatively thin board so that for the production of thick board-like elements such as boards to serve as working surfaces or to present a distinct edge a plurality of such boards must be bonded together using customized adhesives, following which surface treatment is necessary for the formation of rounded edges, grooves at transitions between essentially mutually perpendicular elements or the like.

During the processing of such materials normally a large amount of waste, dust, chips or the like is produced, which more particularly in the case of use of the last named plastic boards are at least in some cases problematical from the health point of view. Moreover, it is to be assumed that generally an excessive inhalation of dust by the operator should be reduced or prevented as far as possible.

### SHORT SUMMARY OF THE INVENTION

One object of the invention is accordingly to provide an aspirating means of the type initially mentioned, with which a power hand tool, more particularly a router, may be fitted without limiting the use of the power hand tool while simultaneously ensuring reliable aspiration of waste, chips or dust produced during the use of such a power hand tool.

In order to achieve these and/or other objects appearing from the present specification, claims and drawings, in the present invention the novel aspiration device, which is based on a means of the type initially mentioned, is essentially characterized in that at the support plate of the tool a more particularly funnel-like orifice means is provided able to receive waste, chips, dust or the like, and able to be releaseably secured or mounted so as to be directed toward the tool bit, to which orifice means by the intermediary of a connection vacuum may be applied for the removal of the waste or, respectively, the chips. Owing to the fact that in accordance with the invention at the support plate of the tool a more particularly funnel-like orifice means is provided directed toward the tool, for example in the form of a router bit, with which a vacuum connection may be or is connected for the removal of the waste or chips or dust, it is possible to ensure that directly at the point where such waste or dust is produced or of the waste produced during processing such waste is taken up and is removed, before it can escape into the surroundings in a fine state of division. Accordingly it is possible to ensure essentially dust-free or waste-free use of the tool. Since in accordance with the invention the orifice means may be attached or mounted in a releasable manner on the support plate or, respectively, guide plate of the tool, it is furthermore possible to ensure that simple dismounting of the means can take place without complex actuating operations or other labor so that in special applications the power hand tool, in the case of which for instance owing to lack of space, aspiration of dust made possible by the aspiration device of the invention can not be made use of, after simple removal of the aspiration device the tool or power hand tool may be used without any modifications.

In order to provide for proper aspiration of waste, dust, chips or the like, in accordance with a preferred embodiment there is the feature that the receiving orifice means opens into an annular suction duct, which is able to be releaseably secured at the outer periphery of the support plate and at the annular duct the vacuum connection is connected or, respectively, is able to be connected. Such an annular suction duct renders it possible for the receiving orifice means to be set at different positions, in accordance with different applications, along of the support plate as is proposed in accordance with a further preferred working example of the aspiration device of the invention. Such an annular suction duct, into which the receiving orifice means opens, moreover renders it possible, irrespectively of the particular position in the receiving orifice means of the aspiration necessary, an essentially fixed or set position for the connection of the vacuum connection to be provided, for example by the intermediary of a flexible pipe.

In accordance with a further preferred embodiment there is a provision such that the receiving orifice means opens by the intermediary of a tubular duct into the annular aspiration duct so that it is possible, in the case of a greater distance of the suction duct from the tool bit, for instance the routing bit, to arrange the receiving orifice means directly adjacent to the tool bit so that there is a correspondingly more reliable and safe take-up of the waste or dust to be removed.

As already indicated for different tasks or, respectively, for moving the power hand tool along curved paths, adjustability of the receiving orifice means in relation to the support plate of the power hand tool may be preferred or desired, in which case more particularly in connection with an essentially annular suction duct in a further preferred embodiment the arrangement is such that the receiving orifice means or the tubular duct opens by means of a slide means into the annular suction duct. Owing to having such a slide means it is possible to ensure that the receiving orifice means may be arranged in an essentially stepless manner in relation to the suction duct and may be connected with same and accordingly, independently of the relative position of the support plate of the power hand tool and the receiving orifice means reliable removal of the waste or dust to be removed or aspirated is made possible.

As regards a direct arrangement of the receiving orifice means adjacent to the tool, as for example a router bit, in accordance with a further preferred embodiment the invention contemplates arranging the suction duct and the receiving orifice means on the surface, facing the workpiece, concentrically in relation to the drive shaft of the tool and furthermore adjacent to the suction duct a support surface is formed projecting toward the workpiece. It is accordingly possible for the receiving orifice means to be positioned suitably near the tool bit taking into account the positioning of the tool, it however being necessary to provide a suitable setting of the annular suction duct together with the receiving orifice means on the surface, facing the tool, of the support plate. Furthermore, an additional support surface must be made available in order to render possible a movement of the receiving orifice means by way of the slide means on the suction duct in relation to support surface or, respectively, support plate of the tool.

In accordance with a modified embodiment the invention contemplates an arrangement or, respectively, attachment of the suction duct on the side or, respectively, surface of the support plate and/or on a holding means between the tool and the support plate and furthermore the annular duct is to be designed for connection with the receiving orifice means on the outer side of the support plate, this design in accordance with the invention more particularly making possible arrangement of the power hand tool directly on the workpiece to be processed. Furthermore, the working stroke of the tool bit normally provided in the case of such a power hand tool may be fully maintained by a hinging or other attachment of the aspiration means on a holding means connected with the support plate. Furthermore, adopting such an arrangement means that there is a simple detachable mounting of the suction duct on the support plate or, respectively, a holding system such that with only a few movements of the hand the aspiration means of the invention may be detached from the power hand tool.

For a further possibility of adjustment, more particularly of the receiving orifice means of the aspiration means of the invention in relation to the bit of the power hand tool the invention furthermore contemplates a further preferred embodiment such that the suction duct is adapted to be vertically adjusted in relation to the support plate.

For further improvement of the aspirating action and more especially to prevent the escape of chips or dust from the power hand tool in an upward direction toward the drive means and accordingly toward the operator, in accordance with a further preferred embodiment the invention contemplates the provision of a preferably detachable cover plate above the support plate and at a distance from same, the free space between the support plate and the cover plate being in communication with the connection of the vacuum supply. Owing to such an additional and preferably detachable cover plate it is possible to ensure that chips, which are slung upward by the router bit, are not distributed in the surroundings, but are moved from the free space between the support plate and the support plate directly to the vacuum connection for the removal of the chips.

In order to be able to avoid having an additional connection or, respectively, an additional vacuum connection for the removal of the waste or, respectively, of the chips, in this respect in accordance with a further preferred embodiment the invention contemplates having a connection opening in the cover plate, such opening being connected by way of a more particularly flexible pipe with the annular suction duct. Accordingly a simple connection is produced between the free space between the support plate and the cover plate and more especially the annular suction duct.

In order to ensure effective sealing as regards attachment in the cover plate and furthermore the passage of a drive shaft through the cover plate the invention furthermore contemplates an arrangement such that brushes are present at the attachment of the cover plate, which is able to be more particularly laterally inserted into a suitable guide, and/or the passage of a drive shaft.

In order to ensure that visibility of the workpiece to be processed is not impaired more particularly adjacent to the tool bit, more especially a router bit, in accordance with a further feature of the invention the cover plate is transparent and more particularly consists of an elastic, tough material. By the use of an elastic or, respectively, tough material it is furthermore possible to ensure that accidental withdrawal of the router bit from its working position does not cause damage to the bit, which is more particularly a router bit, or to the hand tool so that only transparent cover plate must be replaced or changed over.

Owing to the provision of the additional aspiration from the space above the cover plate and more particularly from the free space between the support plate and the cover plate, which is more especially detachable, it is possible to ensure that practically all waste or, respectively, all chips from the workpiece may be removed reliably using a combined aspiration means.

Further advantageous developments and convenient forms of the invention will be understood from the following detailed descriptive disclosure of embodiments thereof in conjunction with the accompanying drawings.

### LIST OF THE SEVERAL VIEWS OF THE FIGURES

FIG. 1 is a diagrammatic side view, partially in section, of a first embodiment of an aspirating means in accordance with the invention for a power hand tool and more particularly a router.

FIG. 2 is a showing, similar to that of FIG. 1, of a modified embodiment of an aspiration means in accordance with the invention.

FIG. 3 is again a view similar to that of FIG. 1 to show a further, modified embodiment of an aspiration means in accordance with the invention.

FIG. 4 shows a further representation, similar to that of FIG. 1, of a modified embodiment of the aspiration means of the invention.

FIG. 5 shows, in a similar view to that of FIG. 1, a further modified embodiment of a aspiration means in accordance with the invention, there being an additional cover plate mounted above the support plate.

FIG. 6 shows a diagrammatic partial plan view of the cover plate as in FIG. 1 looking in the direction of the arrow VI in FIG. 5.

### DETAILED ACCOUNT OF WORKING EMBODIMENTS OF THE INVENTION

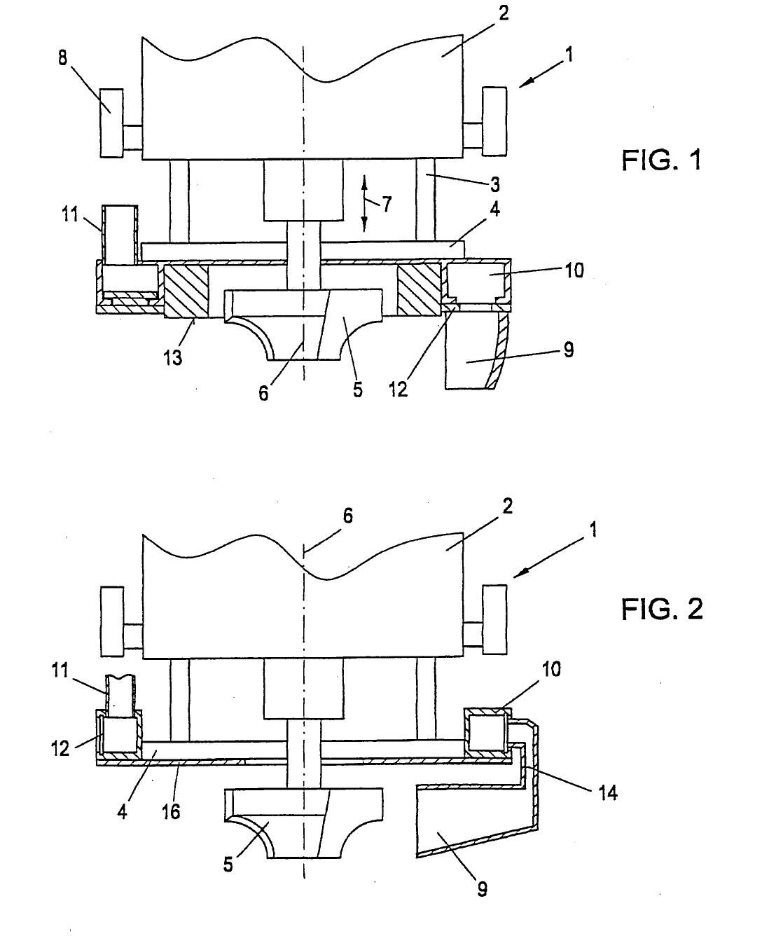

In FIGS. 1 through 4 the reader will perceive a power hand tool generally referenced 1, as for example a router, whose housing 2, which is merely diagrammatically indicated has a support plate 4 mounted on it by way of a support means or holder 3, such support plate 4 being placed on a workpiece, not illustrated in detail. In the illustrated working embodiment a tool bit, constituted by a router bit 5 is able to be rotated by a drive not illustrated in detail about an axis, such drive being accommodated in the housing 2. Moreover, the router bit 5 is normally able to be adjusted in height in relation to the support plate 4, as is indicated by a double arrow 7, operator movements for carrying and manipulating the power hand tool 1 being indicated at 8.

For the removal of waste, chips or dust, which is produced during the processing of workpieces, not illustrated in detail, as for example a wooden board or plastics material, a receiving orifice means 9 is provided at the routing bit 5 on the support plate and such opening 9 opens directly into an annular suction duct 10, such annular suction duct 10 being adapted to be connected by way of a connection 11, as for example a flexible pipe not illustrated in detail, with a vacuum for the removal of the waste or, respectively, dust.

In the case of working embodiment depicted in FIG. 1 the funnel-like receiving orifice means 9, which, as indicated in FIG. 1, opens essentially at the level of the routing bit 5, is able to be slid in relation to the annular suction duct 10 along its periphery, using a diagrammatically indicated slide means 12 so that on moving the power hand tool along curved paths the receiving orifice means 9 may be arranged in the way of the waste or, respectively, dust moving away from the routing bit.

Since in the case of embodiment represented in FIG. 1 the annular suction duct 10 and furthermore the receiving orifice means 9 are arranged on the side, which faces the workpiece (not illustrated in detail) of the support plate, an additional support surface 13 is provided facing the routing bit 5 and such support surface 13 projects slightly past the annular suction duct 10 and, respectively, the slide means 12 so that there is a proper supporting action on the workpiece to be processed, while the receiving orifice means 9 is able to be moved in relation to the suction duct 10.

In the case of the modified embodiment depicted in FIG. 2 there is the departure from the design of FIG. 1 that an annular suction duct, again referenced 10, is mounted on the side, facing away from the workpiece to be processed, of the support plate 4, by way of a positioning or intermediate plate 16, a tubular duct 14 being provided between the receiving orifice means 9 and the suction duct 10 in order again to connect a vacuum duct with the connection 11 to clear the routing bit 5 of dust by way of the funnel-like receiving orifice means through the annular duct 14 into the annular suction duct. To provide for adjustability of the receiving orifice means 9 and of the tubular intermediate duct 14 in relation to the suction duct 10 there is again a slide means which is diagrammatically indicated at 12. In the case of embodiment of FIG. 2 it is therefore possible to arrange or secure the power hand tool 1 using the support plate 4 and the thin intermediate plate 16 on the workpiece to be processed so that any necessary adjustments for the machining of the workpiece may be performed only by, for example, positioning the routing bit 5 and setting a suitable abutment to suit the thickness of the taking into account the thickness of the intermediate plate 16.

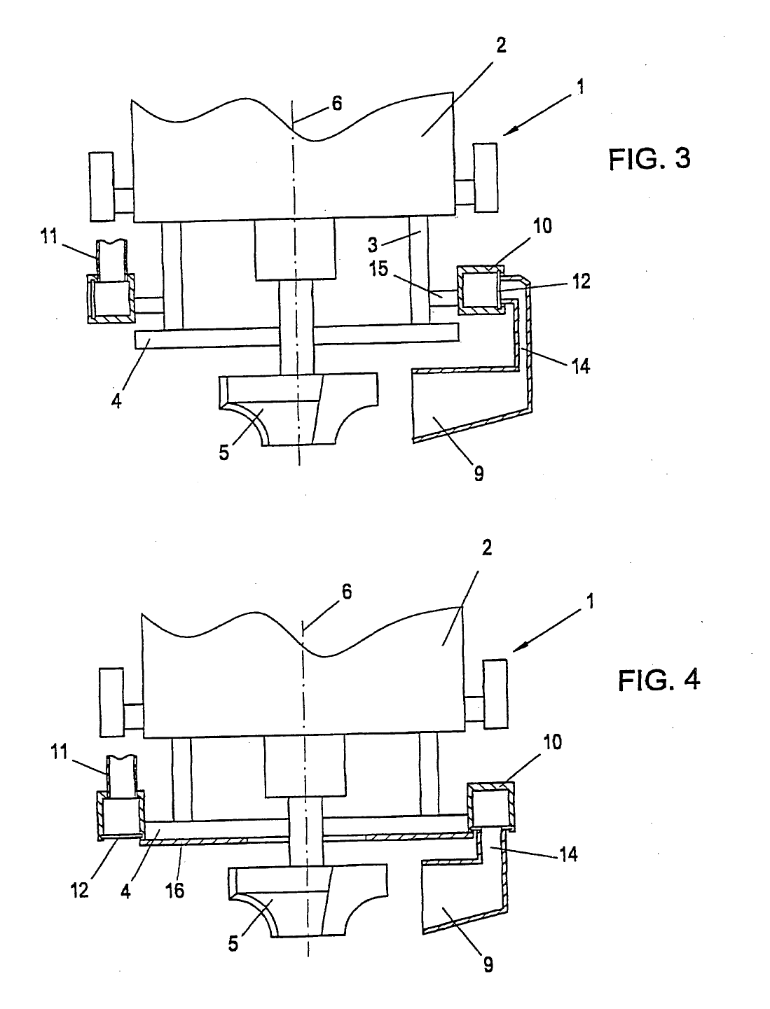

In the case of the embodiment illustrated in FIGS. 3 and 4 as well the annular suction duct 10 is provided on the side, which is turned away from the workpiece, of the support plate 4, a tubular duct 14 being provided between the funnel-like receiving orifice means 9 and the suction duct. The tubular duct 14 and the funnel-like receiving orifice means 9 are, respectively, able to be adjusted using the slide means 12 in relation to the suction duct 10, the removal by aspiration of dust from the suction duct 10 again being possible by connecting up a vacuum line with the connection 11.

In the case of the embodiment of FIG. 3 the suction duct 10 is supported on the holder 3 using a support element 15, whereas in the case of FIG. 4 the suction duct 10 is directly arranged on the outer periphery of a thin positioning or shim plate 16 in between, such plate being able to be secured on the support plate 4.

In all embodiment there is a provision such that the suction duct 10 and as a result the funnel-like receiving orifice means 9 are secured in position for example by means of a simple clamping action on the support plate 4 or, respectively, the holder 3 so that for special applications for example the aspiration means may be dismounted quickly.

Furthermore, owing to the detachable connection of the aspiration means upgrading of existing power hand tools 1 is readily possible.

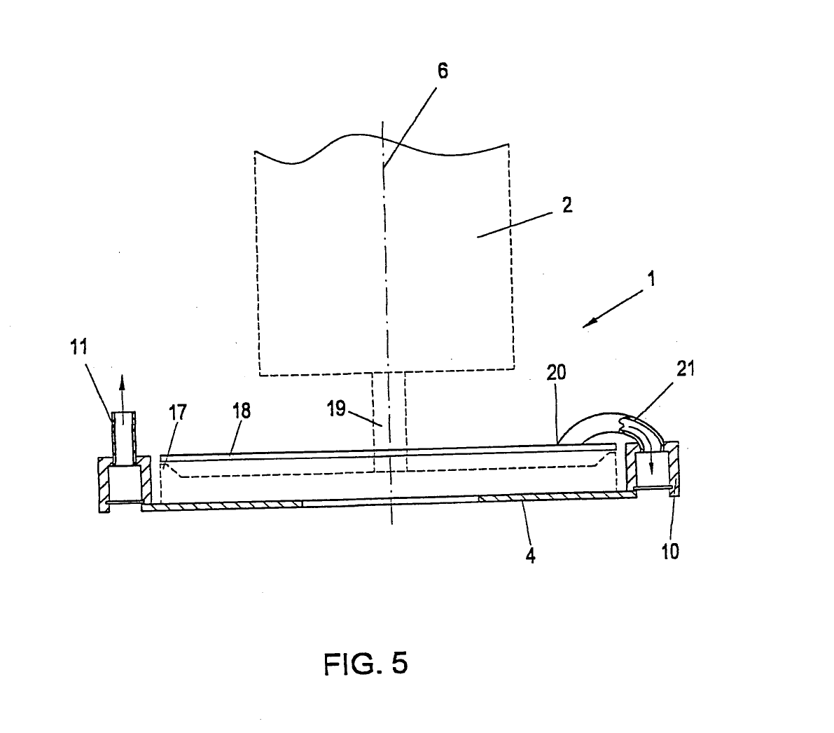

In the case of the view of FIG. 5 showing part of the arrangement it will be clear that above the support plate 4 a more especially detachable cover plate 18 is provided able to be inserted into a guide diagrammatically indicated at 17, the representation of FIG. 5 omitting the tool bit or routing bit and only the drive shaft is indicated at 19.

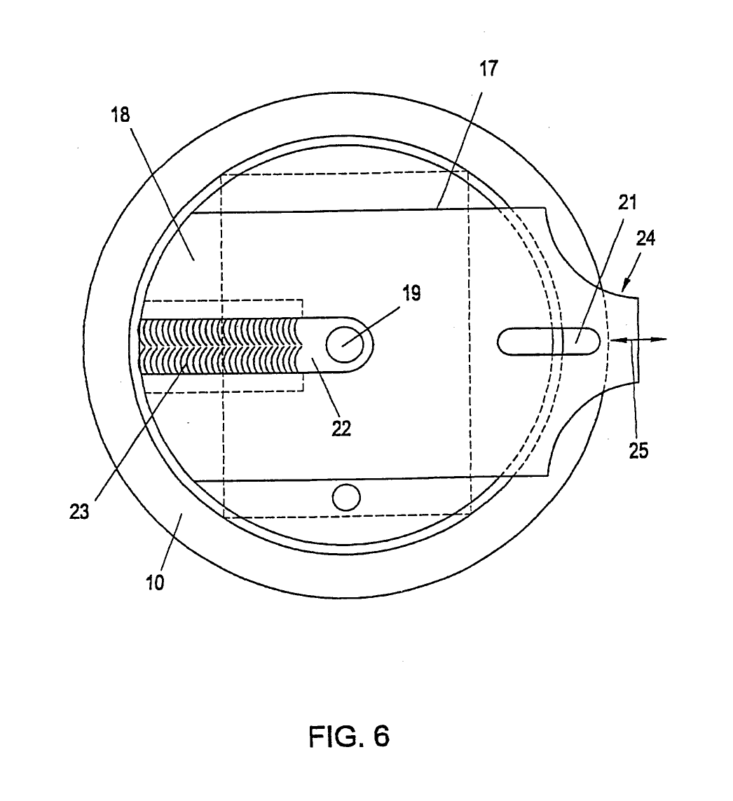

In the case of the partial plan view of FIG. 6 it is furthermore apparent that brushes 23 are provided for sealing a receiving orifice means for the drive shaft 19. Furthermore a handle 24 is provided on the cover plate 18 for moving the cover plate 18 in accordance with the double arrow 25.

The cover plate 18, which is more particularly manufactured of elastic or tough material has an opening 20, which for example is connected by way of a more especially flexible pipe 21 with the annular suction duct 10, which for instance is positioned in a manner similar to the arrangement in FIG. 4, the removal of waste or chips taking place from the annular suction duct 10 like in the previous embodiments by way of a connection 11.

Owing to the provision of the additional cover plate in the embodiment of FIG. 5 it is possible to ensure that not only waste or, respectively, chips may be cleared directly from the routing bit, which is not illustrated in FIG. 5, into the annular suction duct 10, but furthermore some of the chips, which are flung by the routing bit or tool bit toward the drive 2, may be reliably removed by way of suction duct and the connection 11 and accordingly escape into the surroundings is prevented.

1. An aspirating means for a power hand tool, more particularly a router, able to be set on a workpiece to be worked on using a support plate and is able to be moved in relation to the workpiece and the tool, more particularly a router bit, extending through the support plate and being preferably able to be adjusted in relation to the support plate in the vertical direction, wherein at the support plate of the tool a more particularly funnel-like orifice means is provided able to receive waste, chips, dust or the like, and able to be releaseably secured or mounted so as to be directed toward the tool bit, to which orifice means by the intermediary of a connection vacuum may be applied for the removal of the waste or, respectively, the chips.

2. The aspiration means as set forth in claim 1, wherein the receiving orifice means opens into an annular suction duct, which is arranged in a detachable manner at the outer periphery of the support plate and furthermore the means are provided for connecting vacuum with the annular suction duct.

3. The aspiration means as set forth in claim 1, wherein the receiving orifice means is adapted to be moved along the periphery of the support plate for adjustment.

4. The aspiration means as set forth in claim 2, wherein the receiving orifice means or the tubular duct opens into the annular suction duct.

5. The aspiration means as set forth in claim 2, wherein the receiving orifice means or the tubular duct opens by way of a slide means into the annular suction duct.

6. The aspiration means as set forth in claim 2, wherein the suction duct and the receiving orifice means are arranged on the surface, facing the workpiece, of the support plate concentrically to the drive axis of the tool bit and adjacent to the suction duct a support surface is formed projecting toward the workpiece.

7. The aspiration means as set forth in claim 2, wherein the suction duct is arranged on the side or, respectively, surface turned away from the workpiece and/or on a holder between the hand tool and the support plate and the tubular duct is designed for connection with the receiving orifice means on the outer side of the support plate.

8. The aspiration means as set forth in claim 1, wherein the suction duct is adapted to be vertically set in relation to the support plate.

9. The aspiration means as set forth in claim 1, wherein above the support plate and at a distance from the same a preferably detachable cover plate is provided, the free space between the support plate and the cover plate being connected with the vacuum connection.

10. The aspiration means as set forth in claim 9, wherein a connection opening is provided in the cover plate and such connection opening is connected by way of a more particularly flexible pipe with the annular suction duct.

11. The aspiration means as set forth in claim 9, wherein brushes are provided adjacent to point of fixation of the cover plate, which is able to be inserted into a suitable guide, more especially from the side, and/or the passage of a drive.

12. The aspiration means as set forth in claim 9, wherein the cover plate is transparent and more particularly consists of an elastic, tough material.
